(19) United States
(12) Patent Application Publication
(10) Pub. No.: US 2006/0236230 A1
(43) Pub. Date: Oct. 19, 2006

(54) Automatic layout adjustment for documents containing text

(76) Inventors: Xiaofan Lin, Sunnyvale, CA (US); Charles G. Nelson, Palo Alto, CA (US); Hui Chao, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/107,175

(22) Filed: Apr. 15, 2005

(51) Int. Cl. G06F 17/00

(52) U.S. Cl. 715/517

(57) ABSTRACT

In a method for automatically adjusting a document layout including an object containing text, an approximate linear model for the object containing text is created. In addition, a layout quality function is optimized based upon at least one constraint and the approximate linear model for the object is solved based upon the optimized layout quality function. Moreover, the document layout is automatically adjusted based substantially upon the solution to the approximate linear model for the object.

### BACKGROUND

It is relatively common for document layouts to be adjusted to change content or to rearrange content existing on the document. The adjustments in a large number of document layouts are substantially increased in variable data printing or VDP, which generally refers to print jobs where particular objects are substituted for generic objects in the un-customized layout. More particularly, for instance, in VDP, the document layouts are highly customized for the individual recipients of the documents.

The customizations of the document layouts typically require a substantial amount of effort to generally ensure that the adjusted layouts have certain aesthetic levels. In many instances, naïve manipulation of the document layouts often destroys the aesthetics of the adjusted document layouts. By way of example, the naïve manipulation in customizing the document layouts may result in destruction of alignment relationships between various objects, overlap between various ones of the objects, or creation of large gaps between various objects in the document. An experienced operator is typically required to manually adjust the documents to correct these problems, which greatly increases the costs and time associated with producing the customized documents.

It would thus be desirable to have a relatively inexpensive and automated system for adjusting document layouts to substantially maintain relatively high aesthetic levels in the adjusted document layouts.

### SUMMARY

A method for automatically adjusting a document layout including an object containing text is disclosed herein. In the method, an approximate linear model for the object containing text is created. In addition, a layout quality function is optimized based upon at least one constraint and the approximate linear model for the object is solved based upon the optimized layout quality function. Moreover, the document layout is automatically adjusted based substantially upon the solution to the approximate linear model for the object.

### BRIEF DESCRIPTION OF THE DRAWINGS

Features of the present invention will become apparent to those skilled in the art from the following description with reference to the figures, in which:

FIG. 1A depicts a schematic diagram of a layout that includes various objects positioned at various locations in the layout, according to an embodiment of the invention;

FIG. 1B illustrates a modified version of the layout depicted in FIG. 1A, according to an embodiment of the invention;

FIG. 2 shows a graph depicting the stepwise relationship between the height and width of an object containing text, according to an embodiment of the invention;

FIG. 3 illustrates a block diagram of a layout adjustment system suitable for implementing, either fully or partially, various document layout adjustments, according to an embodiment of the invention; and

FIG. 4A illustrates a flow diagram of a method for adjusting a document layout, according to an embodiment of the invention;

FIG. 4B illustrates a flow diagram of a method similar to the method depicted in FIG. 4A, according to an embodiment of the invention;

FIG. 4C illustrates a flow diagram of a method similar to the method depicted in FIG. 4B, according to another embodiment of the invention; and

FIG. 5 illustrates a computer system, which may be employed to perform various functions described herein, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

An automatic document layout adjustment system and method is disclosed herein. The automatic document layout adjustment system and method generally operate to automatically adjust a layout through an integration of content adaptation and the overall layout adjustment. As such, the system and method described herein enables greater flexibility and control in performing automated document adjustments to achieve relatively high aesthetic levels as compared with conventional layout adjustment techniques.

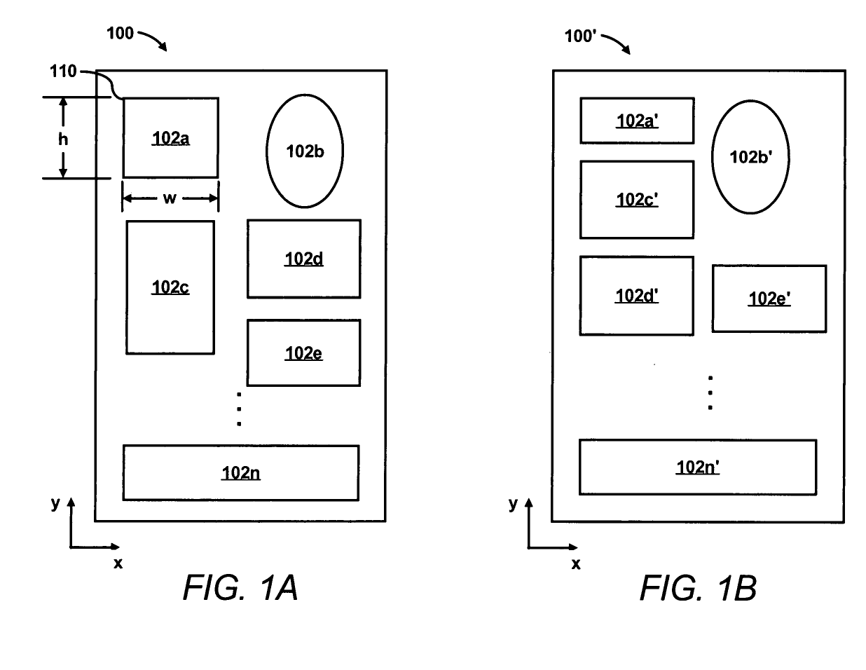

With reference to FIGS. 1A and 1B, there are shown respective diagrams of a first layout 100 and a second, adjusted layout 100′. As shown in FIG. 1A, the first layout 100 includes objects 102a-102n arranged with respect to each other. The second layout 100′ illustrates the objects 102a′-102n′ after the objects 102a-102n have been modified, repositioned or both, as may occur, for instance, in variable data printing (VDP). In any respect, the ellipses “ . . . ” depicted in both FIGS. 1A and 1B generally indicate that any reasonably suitable number of objects may be included in both the first layout 100 and the second layout 100′. It should be understood that the depiction of the objects 102a-102n in FIG. 1A and the objects 102a′-102n′ is for purposes of illustration and is not meant to limit the document layout adjustment systems and methods described herein. Thus, for instance, the first layout 100 may include a different number of objects 102a-102n as compared to the second layout 100′.

The objects 102a-102n, 102a′-102n′ may comprise text, drawings, photographs, graphic designs, or other images. In addition, the objects 102a-102n, 102a′-102n′ may comprise rectangular or non-rectangular shapes. In any event, the objects 102a-102n, 102a′-102n′ may represent the actual rectangular object or a rectangular bounding box of a rectangular or non-rectangular object 102a-102n, 102a′-102n′. For instance, the objects 102a-102n, 102a′-102n′ may represent rectangular bounding boxes for objects containing text that have non-rectangular shapes. In addition, one or more of the objects 102a-102n, 102a′-102n′ may comprise non-rectangular shapes, such as shown with respect to the objects 102b and 102b′. As such, the objects 102a-102n, 102a′-102n′, as used throughout the present disclosure, may be defined as any of the above-identified elements.

The dimensions of the objects 102a-102n, 102a′-102n′, such as width (W) and height (H), may be expressed as a vector X(i), where “i” represents an object 102a-102n. In addition, the positions of the objects 102a-102n, 102a′-102n′ may be specified as a set of coordinates P(i) directed to, for instance, the top left corners 110 of the objects 102a-102n, 102a′-102n′. Moreover, the coordinates P(i) may be defined according to a Cartesian coordinate system. As such, the coordinates P(i) may represent x and y coordinates, with an origin of the x-y coordinate system being located at, for instance, any of the corners of the documents 100, 100′, centers of the documents 100, 100′, or other arbitrarily selected positions in the documents 100, 100′.

In any regard, each of the objects 102a-102n, 102a′-102n′ may be considered as having a reference location 110. The positions and attributes of the objects 102a-102n, 102a′102n′ may be defined as having a position P(i) and a height (H) and width (W) represented by a vector X(i) with respect to the reference location 110. This convention for identifying the positions and dimensions of the objects 102a-102n, 102a′-102n′ is employed throughout the present disclosure for purposes of simplicity. It should, however, be understood that various other manners may be employed to identify the positions and sizes of the objects 102a-102n, 102a′-102n′ without departing from a scope of the document layout adjustment systems and methods described herein.

If the dimensions X(i) of the objects 102a-102n, 102a′-102n′ are fixed in the adjustment between the first layout 100 and the second layout 100′, a set of positions P(i) for the objects 102a-102n, 102a′-102n′ need to be determined in order to optimize a layout quality function. For instance, the Euclidean or Manhattan distance between the first layout 100 and the second layout 100′ may be employed to determine the set of positions P(102a-102n, 102a′-102n′). When each of the objects 102a-102n comprises a rectangular shape, this problem may be formulated as a set of linear constraints and solved with the Simplex algorithm. A description of an example in which linear constraints may be solved as just described to optimize an adjusted layout may be found in co-pending and commonly assigned U.S. patent application Ser. No. ______ TBD, entitled “SYSTEM AND METHOD FOR DOCUMENT LAYOUT ADJUSTMENT”, filed on TBD (Attorney Docket No. 200404369-1). The disclosure contained in that patent application is incorporated by reference herein in its entirety.

However, if objects comprising lines of text whose dimensions X(i) are to be adapted along with an adjustment of the positions P(i) of the objects between the first layout 100 and the second layout 100′, solving for the second layout 100′ may require more sophisticated computations. For instance, when an object 102n comprises text, the relationship between the height (H) and the width (W) of the object 102n may be non-linear. More particularly, for example, when the text content in a rectangular object 102n is fixed, the object's 102n width (W) and height (H) roughly follow:
W(i)*H(i)=a, where a is a constant. Equation (1):

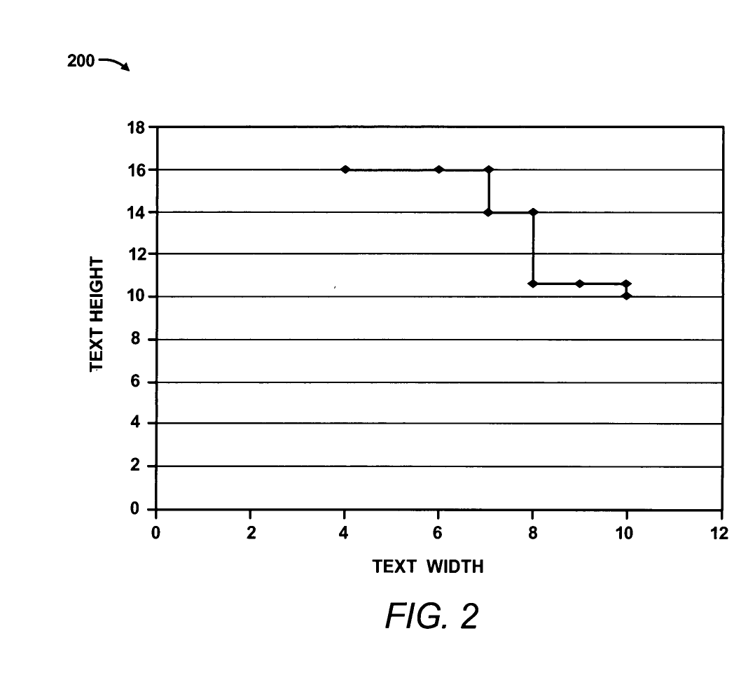

Equation (1) illustrates that a non-linear relationship exists between the width (W) and the height (H) of the object 102n. In addition, the exact relationship between the width (W) and the height (H) of the object 102n is relatively more complex because the height (H) is not a continuous function of the width (H), but instead follows a stepwise pattern. With particular reference to FIG. 2, there is shown a graph 200 depicting the stepwise relationship between the height (H) and width (W) of an object 102n containing text. As shown in FIG. 2, the height-width relationship of the object 102 may comprise a non-continuous stepwise pattern. It should be understood that the graph 200 is merely an example of a possible height-width relationship and is therefore not intended to limit the systems and methods disclosed herein.

As described in greater detail herein below, the dimensions X(i) and the positions P(i) of the objects 102a-102n containing text may substantially be optimized between a first layout 100 and a second layout 100′. In one regard, the contents of the objects 102a-102n may be adjusted along with adjustments to the overall layout.

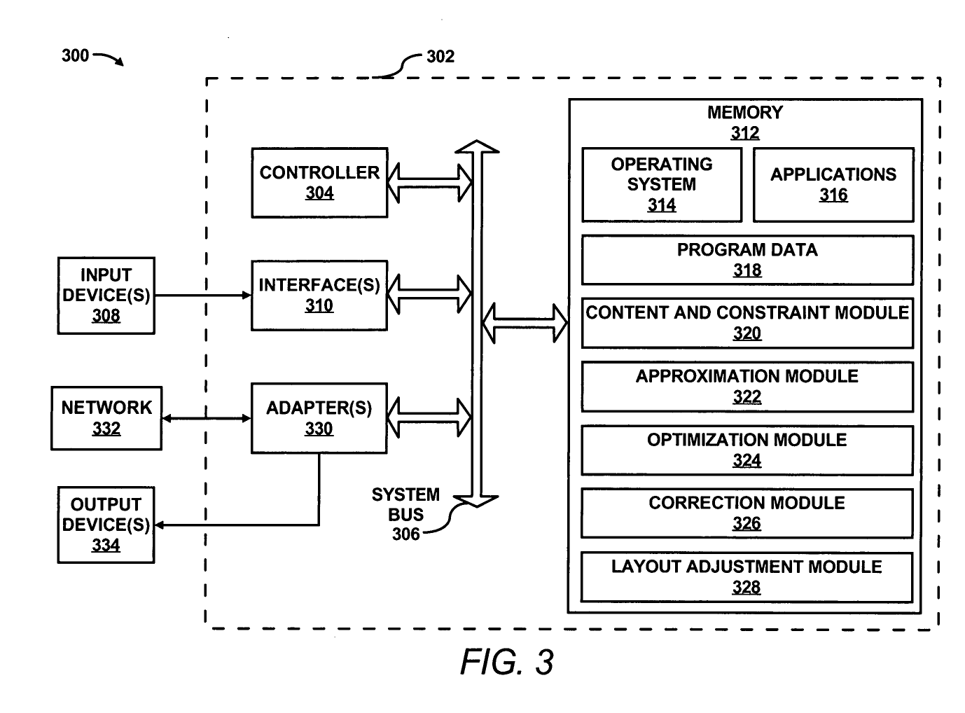

With reference now to FIG. 3, there is shown a block diagram 300 of a layout adjustment system 302 suitable for implementing, either fully or partially, various document layout adjustments described herein. It should be understood that the following description of the block diagram 300 is but one manner of a variety of different manners in which such a layout adjustment system 302 may be configured or operated. In addition, it should be understood that the layout adjustment system 302 may include additional components and that some of the components described may be removed and/or modified without departing from a scope of the layout adjustment system 302. Although the layout adjustment system 302 is depicted as comprising a computing device, various functions of the layout adjustment system 302 may be performed by various software and/or hardware contained in a computing device. However, the following description of the layout adjustment system 302 is set forth with the layout adjustment system 302 comprising a computing device for purposes of simplicity.

The layout adjustment system 302 may comprise a general computing environment and includes a controller 304 configured to control various operations of the layout adjustment system 302. The controller 304 may comprise a microprocessor, a micro-controller, an application specific integrated circuit (ASIC), and the like. Data may be transmitted to various components of the layout adjustment system 302 over a system bus 306 that operates to couple the various components of the layout adjustment system 302. The system bus 306 represents any of several types of bus structures, including, for instance, a memory bus, a memory controller, a peripheral bus, an accelerated graphics port, a processor bus using any of a variety of bus architectures, and the like.

One or more input devices 308 may be employed to input information into the layout adjustment system 302. The input devices 308 may comprise, for instance, a keyboard, a mouse, an image scanner, a disk drive, removable media, flash drives, and the like. The input devices 308 may be used, for instance, to input documents or representations of the documents (that is, the document in code format, which is referred to herein after as a “document” for purposes of simplicity) to the layout adjustment system 302. The input devices 308 may also be employed to input content adaptations and layout constraints into the layout adjustment system 302. The input devices 308 are connected to the controller 304 through an interface 310 that is coupled to the system bus 306. The input devices 308 may, however, be coupled by other conventional interface and bus structures, such as, parallel ports, USB ports, etc.

The controller 304 may be connected to a memory 312 through the system bus 306. Generally speaking, the memory 312 may be configured to provide storage of software, algorithms, and the like, that provide the functionality of the layout adjustment system 302. By way of example, the memory 312 may store an operating system 314, application programs 316, program data 318, and the like. In this regard, the memory 312 may be implemented as a combination of volatile and non-volatile memory, such as DRAM, EEPROM, MRAM, flash memory, and the like. In addition, or alternatively, the memory 312 may comprise a device configured to read from and write to a removable media, such as, a floppy disk, a CD-ROM, a DVD-ROM, or other optical or magnetic media.

The memory 312 may also store modules programmed to perform various layout adjustment functions. More particularly, the memory 312 may store a content and constraint module 320, an approximation module 322, an optimization module 324, a correction module 326, and a layout adjustment module 328. Generally speaking, the controller 304 may implement the modules 320-328 to adjust the layout of a document.

More particularly, the controller 304 may implement the content and constraint module 320 to store information regarding various content adaptations and layout constraints that may be applied during a layout adjustment process. For instance, the content and constraint module 320 may receive and store content to be adapted in an original layout. In addition, the content and constraint module 320 may store various aesthetic rules or constraints as equations in the form of equalities or inequalities. In certain instances, the content and constraint module 320 may encode the aesthetic rules as constraints in the form of equalities or inequalities.

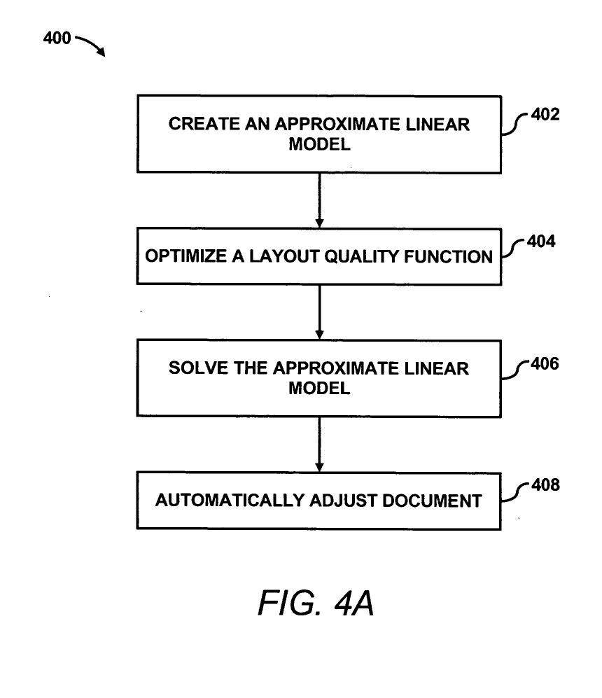

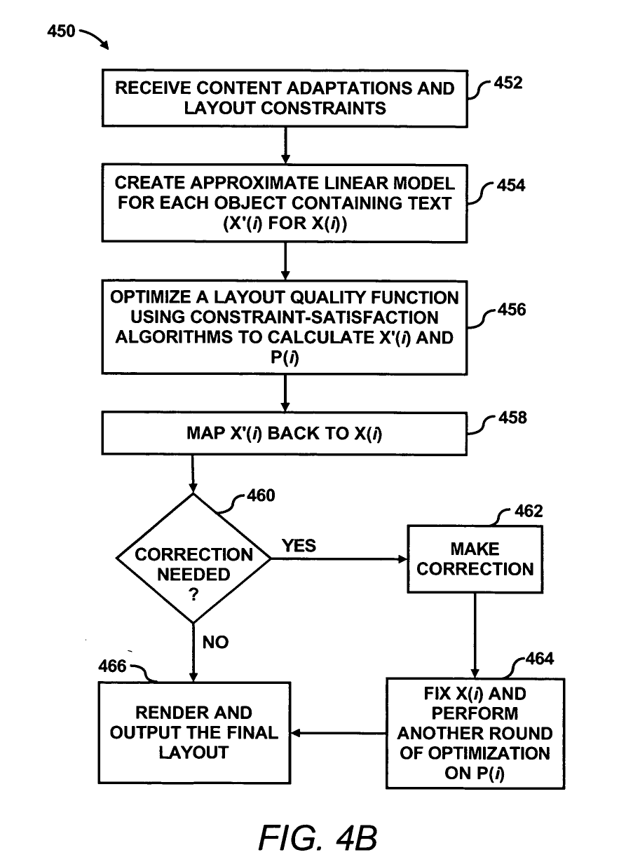

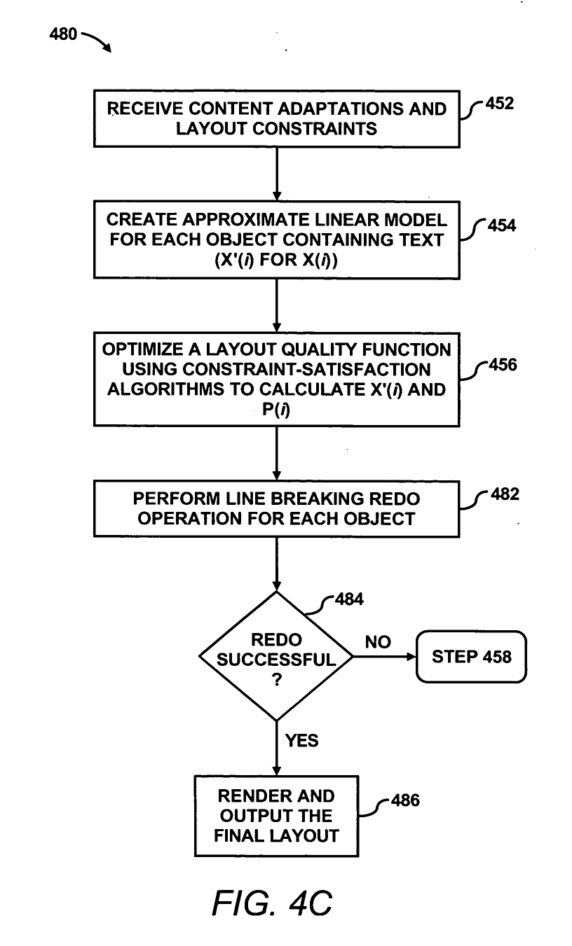

The controller 304 may implement the approximation module 322 to create approximate linear models for objects 102a-102n containing text. More particularly, the approximation module 322 may approximate a linear model that approximately correlates various heights and widths of the objects 102a-102n containing text. Examples of manners in which the approximate linear models may be created are described in greater detail herein below with respect to step 454 in FIG. 4B.

The controller 304 may implement the optimization module 324 to optimize a layout quality function, such as, the Euclidean distance, Manhattan distance, and the like, based upon the approximate linear models and the constraints described above. In optimizing the layout quality function, constraint-satisfaction algorithms may be employed to calculate values for the estimated dimensions X′(i) of the objects 102a′-102n′ and their positions P(i). The constraint satisfaction algorithms may comprise, for instance, the Simplex algorithm.

The controller 304 may implement the correction module 326 to substantially ensure that the values of the estimated dimensions X′(i) for the objects 102a′-102n′ containing text accurately reflect the relationships between the heights and widths of the objects 102a-102n containing text. More particularly, for instance, the controller 304 may implement the correction module 326 to map the estimated heights and widths of the objects 102a′-102n′ back to the original dimensions X(i) to determine whether there are errors in the estimated geometric values. If errors are found, the controller 304 may implement the correction module 326 to replace the erroneous values with correct values.

In addition, or alternatively, the controller 304 may implement the correction module 326 to perform a line breaking redo operation on the adjusted objects 120a′-102n′ to ensure that the text may successfully be contained within the estimated dimensions X′(i) of the adjusted objects 120a′-102n′. More particularly, the controller 304 may implement the correction module 326 to redo the line breaks, and in certain instances, the spacing between characters/words, with the constraint that the stack of lines produced must end up having the estimated height. If it is determined that the stack of lines produced does not end up having the estimated height, the controller 304 may implement the correction module 326 to correct the values of the estimated dimensions X′(i) as described hereinabove.

The controller 304 may implement the layout adjustment module 328 to render the second layout 100′ having the attributes and layout determined through implementation of the modules 320-326. The controller 304 may also implement the layout adjustment module 328 to convert the second layout 100′ into a conventional format such that the second layout 100′ may be output from the layout adjustment system 302.

The second layout 100′ or data pertaining to the second layout 100′ may be transmitted outside of the layout adjustment system 302 through one or more adapters 330. In a first example, the second layout 100′ data may be transmitted to a network 332, such as, an internal network, an external network (the Internet), etc. In a second example, the second layout 100′ data may be outputted to one or more output devices 334, such as, displays, printers, facsimile machines, etc.

Various manners in which the controller 304 performs various document layout adjustment functions are described in greater detail herein below with respect to FIGS. 4A, 4B and 4C.

With reference first to FIG. 4A, there is shown a flow diagram of a method 400 for automatically adjusting a document layout while also adapting the content contained in the document layout. It is to be understood that the following description of the method 400 is but one manner of a variety of different manners in which the layout may be adjusted while adapting the content of one or more objects 102a-102n. It should also be apparent to those of ordinary skill in the art that the method 400 represents a generalized illustration and that other steps may be added or existing steps may be removed or modified without departing from a scope of the method 400.

As shown in the method 400, an approximate linear model for the object containing text is created at step 402. At step 404, a layout quality function is optimized based upon at least one constraint. In addition, at step 406, the approximate linear model is solved for the object based upon the optimized layout quality function. Moreover, the document layout is automatically adjusted based substantially upon the solution to the approximate linear model for the object at step 408.

The steps outlined in the method 400 are described in greater detail herein below with respect to FIGS. 4B and 4C. In addition, FIGS. 4B and 4C describe additional steps that may be performed in conjunction with the steps outlined in the method 400.

With reference to FIG. 4B, there is shown a flow diagram of a method 450 for automatically adjusting a document layout while also adapting the content contained in the document layout. It is to be understood that the following description of the method 450 is but one manner of a variety of different manners in which the layout may be adjusted while adapting the content of one or more objects 102a-102n. It should also be apparent to those of ordinary skill in the art that the method 450 represents a generalized illustration and that other steps may be added or existing steps may be removed or modified without departing from a scope of the method 450. The description of the method 450 is made with reference to the block diagram 300 illustrated in FIG. 3, and thus makes reference to the elements cited therein. It should, however, be understood that the method 450 shown in FIG. 4B is not limited to being implemented by the elements shown in FIG. 3 and may be implemented by more, less, or different elements as those shown in FIG. 3.

The method 450 may be implemented as an automated algorithm for adjusting the layout of objects 102a-102n and for adapting the objects 102a-102n according to various criteria as described below. Adjustments in the layout of the objects 102a-102n generally pertain to positions of the objects 102a-102n in the document. In addition, adaptations of the objects 102a-102n generally pertain to changing attributes of the objects 102a-102n, such as, for instance, the widths of the objects 102a-102n, the font sizes of text contained in the objects 102a-102n, etc.

At step 452, the layout adjustment system 302 may receive content adaptations and layout constraints to be applied to a document having a first layout 100. The document may be stored in the memory 312 and the content adaptations and layout constraints may be received to modify the document such that the document has a second layout 100′. In certain instances, the content adaptations and layout constraints may be received so that the document may be adjusted for a number of individual recipients as, for instance, during variable data printing operations.

In any regard, the content adaptations and layout adjustments may comprise constraints for the layout adjustment system 302 to abide by in adjusting the document layout and adapting the objects 102a-102n contained in the document. In other words, the constraints may comprise various restrictions in the manners in which the second layout 100′ may be adjusted from the first layout 100. The constraints may generally be imposed upon the second layout 100′ in order to retain certain aesthetic requirements in the second layout 100′. In this regard, the constraints may comprise, for instance, alignment constraints, aspect ratio constraints, dimension range constraints, separation constraints, order constraints, etc.

Some of the constraints may also be stored in the form of linear equations. More particularly, the layout adjustment system 302 may receive the constraints in the form of equations having equalities or inequalities. Alternatively, the layout adjustment system 302 may receive the constraints in the form of aesthetic rules which the layout adjustment system 302 may encode into constraints in the form of equations having equalities or inequalities. Various examples of constraints that may be employed by the layout adjustment system 302 are discussed in the co-pending and commonly assigned U.S. patent application Ser. No. ______ TBD, (Attorney Docket No. 200404369-1) described above.

At step 454, approximate linear models for each of the objects 102a-102n containing text are created. In other words, approximate linear content adaptation models are created based upon the new contents of the objects 102a-102n containing text. In addition, for those objects 102a-102n having non-rectangular shapes, rectangular bounding boxes may be employed to define the heights and the widths of those objects 102a-102n. In any regard, the approximate linear models of the text with the adapted content may be created as follows.

An object (i) containing text has the initial dimensions X₀(i), which equates to an initial height H₀(i) and an initial width W₀(i), based upon the original layout of the document. If the width is changed to W⁰(i)+dw, the height must be changed to H₀(i)+dh. However, as stated above and as shown in FIG. 2, dw and dh do not follow a strictly linear relationship, but instead, follow a stepwise pattern.

As such, a linear model that approximates these relationships may be created to define the relationships between the heights and the widths of the object (i). A linear model that approximates the relationship between the dimensions of text blocks for various content is described in co-pending and commonly assigned U.S. patent application Ser. No. ______ TBD, entitled “HEIGHT-WIDTH ESTIMATION MODEL FOR A TEXT BLOCK”, filed on TBD (Attorney Docket No. 200404371-1), the disclosure of which is hereby incorporated by reference in its entirety. As disclosed in that patent application, if the change between the content of the original text block and the adapted text block is below a certain threshold, the relationship between the dimensions of the text blocks may be regarded as being approximately linear, such that:
dh=k*dw, where k is a constant. Equation (2):

In Equation (2), k may be solved experimentally by setting the object (i) to another width W₁(i), placing the content into the object (i) and obtaining a new height H₁(i) for the object (i). Thus, Equation (1) may be rewritten as:

$$Equation ( 3 ) \text{:}$$

$$k = \frac{{H}_{1} ( i ) - {H}_{0} ( i )}{{W}_{1} ( i ) - {W}_{0} ( i )} .$$

Based upon Equation (3), the linear model of the object (i) may be written as:
H=H₀+k*(W−W₀). Equation (4):

In certain instances, the linear model may also include other attributes, such as, font size, letter spacing, word spacing, etc. As such, at least one of the other attributes may also be considered in adjusting the layout 100. By way of example with respect to font sizes, Equation (4) may be written as:

Equation (5): H=H₀+k₁*(W−W₀)+k₂*(FS−FS₀), where k₁ and k₂ are constants, FS is the changed font size, and FS₀ is the initial font size. The constants k₁ and k₂ may be solved experimentally by setting the object (i) to another width W, setting the font size of the text to FS, and placing the content into the object (i), obtaining a new height H. Although Equation (5) is described with the use of font sizes as the other attributes, Equation (5) may be written in similar manners such that the other attributes may be considered in adjusting the layout 100.

In addition, Equations (4) and (5) may be solved through linear regression techniques as also disclosed in U.S. patent application Ser. No. ______ TBD (Attorney Docket No. 200404371-1).

According to another example, the linear models for the objects 102a-102n containing text may be approximated through use of a differentiable model. In this example, a formula that approximately models the number of lines (m) as a function of width (W) may be chosen. If the chosen formula is non-linear, the formula is differentiated to obtain an approximate linear model for the number of lines (m) as a function of the line width (W). For instance, a very high-quality line-breaking algorithm does not squeeze or stretch any line very much, and therefore, the total area of the text will stay roughly constant, independent of the number of lines (m) to which it is divided. This suggests an analytic model relationship between the area (A), height (H) and width (W) as:
A=W*H, for some constant area (A). Equation (6):

By way of example, if (40, 60) were one feasible (width, height) pair, then to the first order in the neighborhood of (40, 60), Equation (6) implies that:

ΔA=60*ΔW+40*ΔH, so the line that the model predicts is: Equation (7):
H=60−(3/2)(W−40). Equation (8):

At step 456, a layout quality function, such as, the Euclidean distance, the Manhattan distance, and the like, between the original layout 100 and the second layout 100′, may be optimized. In optimizing the layout quality function, values for the estimated dimensions X′(i) of the adjusted object (i) containing text and the positions P(i) of the objects (i) may be calculated using constraint-satisfaction algorithms, such as the Simplex algorithm. In addition, the approximate linear models created at step 454 and the layout constraints received at step 452 may be combined with any additional constraints to obtain an approximation of the positions and sizes of the adjusted objects 102a′-102n′. The additional constraints may include, for instance, various linear constraints to substantially ensure that the second layout 100′ retains certain aesthetic levels. By way of example, an additional constraint may be introduced to enable sufficient space to be retained in the second layout 100′ for the oval object 102b. The additional constraint in this example may therefore comprise a constraint on the estimated width W′(102a) of the object 102a′, which may be written in equation form as:
W′(102a)−W₀(102a)≦c, where c is a constant. Equation (9):

As stated above, the constraints may be solved through use of a constraint-satisfaction algorithm, such as, the Simplex algorithm, to optimize the layout quality function. Examples of various manners in which constraints may be solved in this manner are set forth in the co-pending U.S. patent application Ser. No. ______ TBD, (Attorney Docket No. 200404369-1), which is incorporated by reference herein in its entirety. That Application also discloses various methods of optimizing the layout quality function based upon minimizing the Manhattan distance between the original layout 100 and the second layout 100′.

At step 458, the estimated dimensions X′(i) calculated at step 456 may be mapped back to the original dimensions X(i) to determine whether there are errors in the estimated dimensions X′(i). In addition, at step 460, it may be determined as to whether the values for the estimated heights of the objects 102a-102n solved for at step 456 accurately correspond to the estimated widths of the objects 102a-102n. Step 460 may be performed, for instance, because the linear models for the objects 102a-102n created at step 454 are approximations.

The comparison may be based upon the actual height that correlates to a given width for each of the objects 102a-102n, which may be determined through actual content placement of the objects 102a-102n with the widths fixed at the values calculated at step 456. The actual correlation between the height and the width of an object 102n may be determined through use of any reasonably suitable known line-breaking algorithm.

If it is determined that the calculated height differs from the actual height for an object 102n, a correction may be made to the object 102n, such that the height of the object 102n may be fixed to the actual height, as indicated at step 462. To provide a better understanding of steps 458-462, an example is provided below based upon a number of constraints, including the following constraint for the dimensions for object 102c:
ΔH(102c)=119.6−ΔW(102c)*0.52. Equation (10):
As shown in Equation (10), the Δheight of the object 102c (ΔH(102c)) is constrained to have a certain relationship with the Δwidth of the object 102c (ΔW(102c)). The “Δ” in this example indicates a relative value between the adjusted layout and the original layout. In this example, a solution to the constraints to optimize a layout quality function, and solved through use of a constraint-satisfaction algorithm, outputted an indication that the Δwidth of the object 102c (ΔW(102c)) is equal to 37.19 and that the Δheight of the object 102c (ΔH(102c)) is equal to 140.46. The relationship between the Δwidth of the object 102c (ΔW(102c)) and the Δheight of the object 102c (ΔH(102c)) is based upon the linear model approximated at step 454, and thus may be inaccurate. More particularly, for instance, the relationship may be inaccurate because the text may have been broken into a number of lines whose width is the solution width and the height of the total number of lines may be more than or less than the solution height.

A determination may be made as to whether the Δheight of the object 102c (ΔH(102c)=140.46) is an accurate value relative to the Δwidth of the object 102c (ΔW(102c)=37.19). This determination may be made by actually placing the text in the object 102c under the condition that the Δwidth of the object 102c (ΔW(102c))=37.19. The determination of the Δheight of the object 102c (ΔH(102c)) may also be performed through any reasonably suitable line-breaking algorithm, for instance. The Δheight of the object 102c (ΔH(102c)) in this example may be equal to 153.52, which differs from the Δheight value calculated for the object 102c at step 456. As such, the less accurate value of 140.46 is replaced with the more accurate value of 153.52 for the Δheight of the object 102c (ΔH(102c)) for subsequent operations in the method 450.

Following step 462, the dimensions (X(i)) of the objects 102a-102n may be fixed and another round of optimization may be performed on the positions (P(i)) of the objects 102a-102n, at step 464. More particularly, the positions (P(i)) of the objects 102a-102n may be optimized using constraint-satisfaction algorithms, for instance, as described with respect to step 456. In addition, the constraints employed at step 464 for the dimensions (X(i)) of the objects 102a-102n may include the widths for the objects 102a-102n determined at step 454 and the corresponding heights for the objects 102a-102n determined at step 462. Thus, with respect to the example described above, the constraint depicted by Equation (10) may be replaced as follows at step 464:
ΔW(102c)=37.19. Equation (11):
ΔH(102c)=153.52. Equation (12):

The solutions to the equations calculated by a constraint-solving algorithm to optimize a layout quality function for the positions (P(i)) of the objects 102a-102n at step 464 may differ from the solutions calculated at step 456 because the equations identifying the constraints have changed from those employed at step 456.

At step 466, if it is determined at step 460 that no corrections are needed, the second layout 100′ may be rendered such that the objects 102a′-102n′ have the dimensions X′(i) and are positioned according to the positions P(i) determined at step 456. In addition, at step 466, the second layout 100′ may be rendered such that the objects 102a′-102n′ have the dimensions (X(i)) determined at step 458 and the objects 102a′-102n′ are positioned according to the positions (P(i)) of the objects 102a′-102n′ determined at step 464, if a correction is made at step 462. In either case, step 466 may also include outputting of the second layout 100′ in any reasonably suitable format, such as, a portable document file (PDF).

With reference now to FIG. 4C, there is shown a flow diagram of a method 480 for automatically adjusting a document layout while also adapting the content contained in the document layout, according to another example. The method 480 contains many of the same or similar steps as contained in the method 450. As such, the same or similar steps will not be described in detail with respect to the method 480. Instead, the differences between the method 480 and the method 450 will be described below.

In this respect, following step 456, a line breaking redo operation is performed at step 482. A description of the line breaking redo operation is presented by way of the following example. An object 102n contains text and is subject to a text constraint. In addition, a solution of the approximate constraints produces a solution with the object positioned at P(102n) and having the dimensions W(102n) and H(102n) estimated at step 456. In this method, the line breaks for the object 102n are recomputed using the estimated width W(102n) and choosing the breaks to produce the best line-breaking possible subject to the extra constraint that the stack of lines produced must end up having the estimated height H(102n). In other words, the line breaks of the text, and in certain instances, the spacing between words/characters, contained in the object 102n may be modified such that the object 102n has the estimated height H(102n).

At step 484, it may be determined as to whether the line breaking redo operation was successful. The line breaking redo operation may, in certain instances, be unable to fit the text into the estimated height H(102n), and may thus be unsuccessful. In this instance, some of the steps contained in the method 450 may be invoked beginning at step 458 (FIG. 4B). In addition, steps 460-466 may also be performed following step 458 as described hereinabove.

If, however, it is determined at step 484 that the line breaking redo operation was successful, the second layout 100′ may be rendered such that the objects 102a′-102n′ have the dimensions X′(i) and are positioned according to the positions P(i) determined at step 456.

Through implementation of one or more of the methods 400, 450 and 480, adjustments in the contents of the objects 102a-102n may be performed in an integrated manner with the overall adjustment of a layout 100. As such, the methods 400, 450, and 480 described herein enable greater flexibility and control in performing automated document adjustments to achieve relatively high aesthetic levels as compared with conventional layout adjustment techniques.

Some or all of the operations illustrated in the methods 400, 450, and 480 may be contained as a utility, program, or a subprogram, in any desired computer accessible medium. In addition, the methods 400, 450, and 480 may be embodied by a computer program, which can exist in a variety of forms both active and inactive. For example, they can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

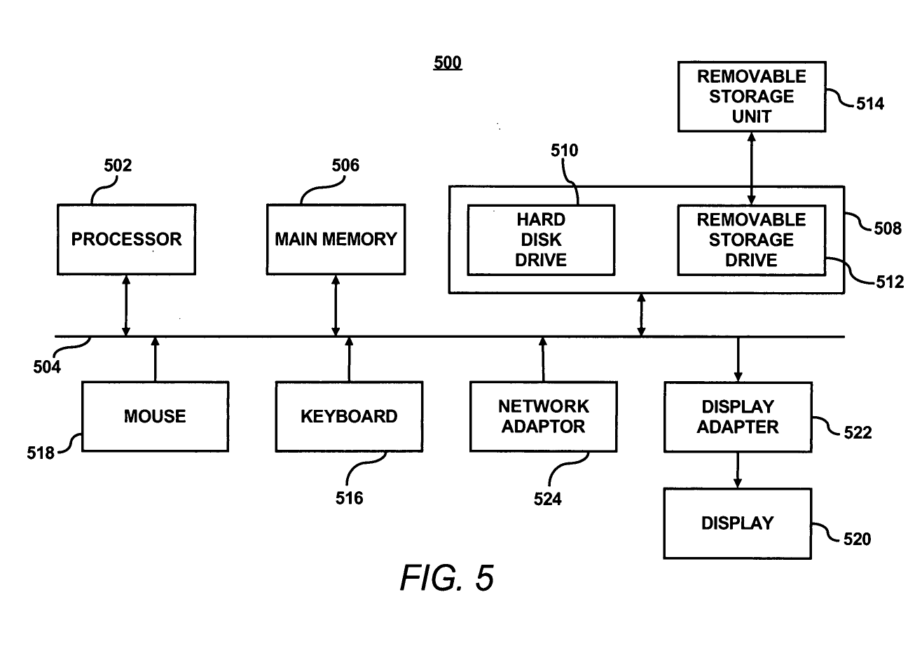

FIG. 5 illustrates a computer system 500, which may be employed to perform various functions described herein. The computer system 500 may include, for example, the controller 304. In this respect, the computer system 500 may be used as a platform for executing one or more of the functions described herein above with respect to the various components of the layout adjustment system 302.

The computer system 500 includes one or more controllers, such as a processor 502. The processor 502 may be used to execute some or all of the steps described in the methods 400, 450 and 480. Commands and data from the processor 502 are communicated over a communication bus 504. The computer system 500 also includes a main memory 506, such as a random access memory (RAM), where the program code for, for instance, the controller 304, may be executed during runtime, and a secondary memory 508. The secondary memory 508 includes, for example, one or more hard disk drives 510 and/or a removable storage drive 512, representing a floppy diskette drive, a magnetic tape drive, a compact disk drive, etc., where a copy of the program code for the layout adjustment system 302 may be stored.

The removable storage drive 510 reads from and/or writes to a removable storage unit 514 in a well-known manner. User input and output devices may include a keyboard 516, a mouse 518, and a display 520. A display adaptor 522 may interface with the communication bus 504 and the display 520 and may receive display data from the processor 502 and convert the display data into display commands for the display 520. In addition, the processor 502 may communicate over a network, for instance, the Internet, LAN, etc., through a network adaptor 524.

It will be apparent to one of ordinary skill in the art that other known electronic components may be added or substituted in the computer system 500. In addition, the computer system 500 may include a system board or blade used in a rack in a data center, a conventional “white box” server or computing device, etc. Also, one or more of the components in FIG. 5 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method for automatically adjusting a document layout including an object containing text, said method comprising:
creating an approximate linear model for the object containing text;
optimizing a layout quality function based upon at least one constraint;
solving the approximate linear model for the object based upon the optimized layout quality function; and
automatically adjusting the document layout based substantially upon the solution to the approximate linear model for the object.

2. The method according to claim 1, wherein the step of optimizing the layout quality function further comprises optimizing the layout quality function by using a constraint-satisfaction algorithm.

3. The method according to claim 1, wherein the step of optimizing the layout quality function further comprises optimizing at least one of the Euclidean distance and the Manhattan distance of the object between a first position and an adjusted position.

4. The method according to claim 1, wherein the step of creating the approximate linear model comprises creating a linear model that approximately correlates dimensions of the object for the adjusted layout, wherein the dimensions comprise a height and a width of the object.

5. The method according to claim 4, wherein the step of creating the linear model further comprises creating a linear model that considers another attribute of the object, wherein the another attribute comprises at least one of font size, letter spacing, and word spacing.

6. The method according to claim 4, wherein the step of solving the approximate linear model further comprises solving for estimated dimensions of the object, said estimated dimensions comprising an estimated height and an estimated width of the object.

7. The method according to claim 6, further comprising:
determining whether an estimated dimension of the object is inaccurate; and
correcting an estimated dimension in response to a determination that at least one of the estimated height and the estimated width is inaccurate.

8. The method according to claim 7, wherein the step of determining whether an estimated dimension is inaccurate further comprises comparing the estimated height to a first height of the object and determining that the estimated height is inaccurate in response to the estimated height differing from the first height, wherein the first height is the actual height corresponding to the estimated width.

9. The method according to claim 8, wherein the step of correcting an estimated dimension of the object further comprises replacing the estimated height with the first height in defining the estimated dimensions of the object.

10. The method according to claim 9, wherein the object is defined by a position with respect to the document layout, said method further comprising:
optimizing the layout quality function based upon the estimated dimensions of the object to thereby optimize an adjusted position of the object in the layout; and
wherein the step of automatically adjusting the document layout further comprises automatically adjusting the document layout such that the object has the estimated dimensions and is positioned at the adjusted position in the adjusted document layout.

11. The method according to claim 10, wherein the step of optimizing a layout quality function based upon the estimated dimensions of the object further comprises optimizing at least one of the Euclidean distance and the Manhattan distance of the object between a first position and the adjusted position.

12. The method according to claim 1, further comprising:
performing a line breaking redo operation on the object; and
determining whether the line breaking redo operation was successful.

13. The method according to claim 12, further comprising:
determining whether an estimated dimension of the object is inaccurate in response to a determination that the line breaking redo operation was unsuccessful;
correcting an estimated dimension in response to a determination that at least one of the estimated height and the estimated width is inaccurate;
optimizing the layout quality function based upon the estimated dimensions of the object to thereby optimize an adjusted position of the object in the layout; and
wherein the step of automatically adjusting the document layout further comprises automatically adjusting the document layout such that the object has the estimated dimensions and is positioned at the adjusted position in the adjusted document layout.

14. The method according to claim 1, wherein the document layout comprises a plurality of objects containing text, and wherein the method further comprises:
creating approximate linear models for the plurality of objects;
optimizing a layout quality function based upon the at least one constraint;
solving the approximate linear models for the plurality of objects based upon the optimized layout quality function;
determining whether estimated dimensions of the plurality of objects are inaccurate;
for those objects whose estimated dimensions are determined as being inaccurate, correcting an estimated dimension;
optimizing a layout quality function based upon the corrected estimated dimensions of the object to thereby optimize estimated positions of the plurality of objects in the layout; and
wherein the step of automatically adjusting the document layout further comprises automatically adjusting the document layout such that the plurality of objects have the estimated dimensions and are positioned at the estimated positions in the adjusted document layout.

15. The method according to claim 14, wherein the step of creating approximate linear models comprises creating linear models that approximately correlate dimensions of the plurality of objects for the adjusted layout, wherein the dimensions comprise respective heights and widths of the plurality of objects.

16. The method according to claim 1, wherein the object containing text comprises a non-rectangular shape, the method further comprising:
employing a rectangular bounding box to define a height and a width of the object in creating the approximate linear model for the object.

17. A system for adjusting a document layout including an object containing text, said system comprising:
a memory storing a plurality of layout adjustment modules; and
a controller configured to implement the plurality of layout adjustment modules to optimize a layout quality function based upon at least one constraint, to solve an approximate linear model for the object based upon the optimized layout quality function, and to adjust the document layout based substantially upon the solution to the approximate linear model for the object.

18. The system according to claim 17, wherein the controller is configured to optimize at least one of the Euclidean distance and the Manhattan distance of the object between a first position and a second position to optimize a layout quality function.

19. The system according to claim 17, wherein the controller is configured to solve for estimated dimensions of the object, to determine whether an estimated dimension of the object is inaccurate, and to correct the estimated dimensiond in response to an estimated dimension being in accurate.

20. The system according to claim 19, wherein the controller is further configured to determine the correct dimensions and to replace the inaccurate estimated dimension with the correct dimension.

21. The system according to claim 20, wherein the controller is further configured to optimize the layout quality function based upon the estimated dimensions, including the correct dimension, to optimize an adjusted position of the object and, wherein the controller is further configured to adjust the document layout, such that, the object has the estimated dimensions and is positioned at the adjusted position.

22. The system according to claim 17, wherein the controller is further configured to perform a line breaking redo operation on the object.

23. A computer system comprising:
means for optimizing a layout quality function for a document layout containing an object, wherein the object contains text;
means for solving an approximate linear model for the object;
means for adjusting the document layout based substantially upon a solution to the approximate linear model.

24. The computer system according to claim 23, further comprising:
means for determining whether the solution to the approximate linear model is accurate;
means for replacing an inaccurate solution with an accurate solution; and
means for solving for an estimated position of the object.

25. A computer readable storage medium on which is embedded one or more computer programs, said one or more computer programs implementing a method for automatically adjusting a document layout including an object containing text, said one or more computer programs comprising a set of instructions for:
creating an approximate linear model for the object containing text;
optimizing a layout quality function based upon at least one constraint;
solving the approximate linear model for the object based upon the optimized layout quality function;
determining whether estimated dimensions of the object is inaccurate;
correcting an estimated dimension in response to a determination that the estimated dimension is inaccurate;
optimizing a layout quality function based upon the corrected estimated dimension of the object to thereby optimize an estimated position of the object in the layout; and
automatically adjusting the document layout such that the object has the estimated dimensions and is positioned at the estimated position in the adjusted document layout.
